(19) United States
(12) Patent Application Publication
(10) Pub. No.: US 2002/0107678 A1
(43) Pub. Date: Aug. 8, 2002

(54) Virtual computer verification platform

(76) Inventors: Chuan-Lin Wu, Hsinchu (TW); Yuan-Long Chang, Shinjuang City (TW); Jen-Te Lee, Taichung (TW)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 09/778,264

(22) Filed: Feb. 7, 2001

(51) Int. Cl. G06F 17/50

(52) U.S. Cl. 703/14

(57) ABSTRACT

A virtual computer verification platform is provided with a verifying and debugging environment so as to develop a new microprocessor chip, a new system software, a new firmware and a new peripheral chip. The virtual computer verification platform includes a simulation system and a set of on-line debugging auxiliary tools, wherein the microprocessor chip can be designed in a Behavior model, a RTL model and a Gate model. The message communication for integrating the whole simulation system is implemented through a message passing mechanism supported by UNIX IPC (Inter-Process Communication) and PLI (Programming Language Interface) supported by Verilog.

### FIELD OF THE INVENTION

The present invention relates to a verification platform, and more particularly to a virtual computer verification platform.

### BACKGROUND OF THE INVENTION

Computers have been widely used in our society for various purposes. Typically, a computer system principally comprises a microprocessor, a software, a memory device and a plurality of peripheral devices for performing many functions by executing a plurality of commands. Owing to the rapid progressiveness of the computer system, an advancing technology for verifying and debugging the computer system is developed to understand the performance and problems associated with a new component, such as a peripheral device and a chipset. Therefore, it is more convenient, more time-consuming, more efficient and less costly by using a virtual computer verification platform than using a real computer.

A virtual computer verification platform has been found in verifying an Intel 80486 compatible microprocessor chip. Such virtual computer verification platform is designed by using an instruction-based simulation, wherein the processing events are simulated and calculated in an instruction cycle. The instruction-based simulation has an advantage of executing the instruction behavior of a simulating microprocessor rapidly. However, such verification platform has various disadvantages as follows:

(1) the verifications between the microprocessor and peripheral protocol signals are not provided;

(2) the microprocessor configured on the verification platform is designed in terms of a C-like programming language by using a behavior model, which is apparently distinguished from the circuit of the real microprocessor chip;

(3) the behavior model can only be applied to a software such that the function for debugging the microprocessor chip is not provided, and

(4) the verification functions of the microprocessor chip can not be used in RTL (Register Transfer Level) mode and Gate mode.

Accordingly, a need exists in the industry for overcoming the above drawbacks.

### SUMMARY OF THE INVENTION

It is an object of the present invention to provide a virtual computer verification platform with a verifying and debugging environment so as to develop a new microprocessor chip, a new system software, a new firmware and a new peripheral chip.

It is another object of the present invention to provide a virtual computer verification platform including (1) a simulation system and (2) a set of on-line debugging auxiliary tools.

In accordance with the first aspect of the present invention, the simulation system includes a special function for integrating a microprocessor chip with the simulation system, a concurrent-clock circuit inserted into the microprocessor chip, a peripheral chip simulation subsystem, a peripheral device simulation subsystem and a bus command compiler.

Certainly, the microprocessor chip can be designed in a Behavior model, a RTL model and a Gate model.

Preferably, the microprocessor chip is coded in a high level hardware description language, such as Verilog.

Preferably, the special function is vpm_call () written in a C high level programming language and is used for transferring an interface signal from the microprocessor chip to the peripheral chip simulation subsystem through a message passing mechanism supported by UNIX IPC (Inter-Process Communication) and PLI (Programming Language Interface) supported by Verilog.

Preferably, the concurrent-clock circuit is used for creating a synchronic clock between the simulation system and the microprocessor chip, collecting the interface signal from the microprocessor in each clock cycle, delivering the special function into the simulation system beyond the microprocessor chip in a leading edge and a trailing edge of each synchronic clock cycle, and waiting for a result to achieve synchronic transfer and data transfer.

Preferably, the peripheral chip simulation subsystem is used for integrating each individual virtual peripheral chip and is designed in terms of an object-oriented programming technology for providing a peripheral control chipset of the simulation system with performance, interface protocol and clock.

Preferably, the peripheral device simulation subsystem is used for integrating individual virtual peripheral device and is also designed in terms of an object-oriented programming technology for providing a peripheral device of the simulation system with performance.

Preferably, the bus command compiler is used for compiling a protocol signal command from the microprocessor chip and transferring a compiled command into the peripheral chip simulation subsystem.

In accordance with the second aspect of the present invention, the set of on-line debugging auxiliary tools connected to the virtual computer simulation system for modifying the contents of the peripheral device to assist the microprocessor chip in debugging includes as follows:

(1) a Graphic User Interface which is implemented by using a C++ programming language in terms of a X-Windows, a Motif program library, a UNIX standard system service program library, a Perl programming language and a Tcl/Tk,

(2) a first compiler for displaying and revising contents of a memory,

(3) a second compiler for displaying and revising contents of a virtual harddisk,

(4) a set of harddisk low level management tools capable of reading a parameter table of the virtual harddisk and formatting the virtual harddisk in low level,

(5) a set of MS-DOS compatible file system management tools for implementing a file system operation of the simulation system when no operating system is executed, including partition and labeling of the harddisk, formatting a MS-DOS file, copying a file, deleting a file, establishing a directory, and deleting a directory for facilitating the operation system installation of the simulation system, and

(6) a BIOS (Basic Input Output System) chip written tool for writing a ROM image file of a new BIOS program into the microprocessor chip of the virtual computer simulation system.

In accordance with the third aspect of the present invention, the virtual computer verification platform is designed in terms of an object-oriented programming technology, and implemented on Sun workstation for simulating the functions of a computer in real world.

In accordance with the fourth aspect of the present invention, the virtual computer verification platform is divided into four layers, i.e. a peripheral device layer, a chipset layer, a bus interface command and protocol layer, and a microprocessor layer. In these layers, the microprocessor is coded in a high level hardware description language, such as Verilog, and the other layers are designed in terms of an object-oriented programming technology and implemented in a high level programming language, e.g. C++.

In accordance with the fifth aspect of the present invention, the virtual computer verification platform of the present invention is implemented by using a clock-based simulation.

In accordance with the sixth aspect of the present invention, the virtual computer verification platform of the present invention has been found for successfully verifying the micro-configuration of Intel x86 compatible microprocessors and making the advancing developments thereof.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a logical block diagram illustrating the simulation system of a virtual computer verification platform according to the present invention;

FIG. 2 is a logical block diagram showing the device of a simulation system according to the present invention;

FIG. 3 is an operating window interface displaying a virtual computer verification platform according to the present invention;

FIG. 4 is an operating window interface displaying the storage of data for a virtual harddisk according to the computer verification system of the present invention;

FIG. 5 is another operating window interface displaying the edit window for a virtual harddisk according to the computer verification system of the present invention;

FIG. 6 is an operating window interface displaying a virtual memory device according to the computer verification system of the present invention; and

FIG. 7 is a block diagram illustrating information communication of a computer verification system according to the present invention.

### DETAILED DESCRIPTION OF THE PREFERRED EMBODIMENT

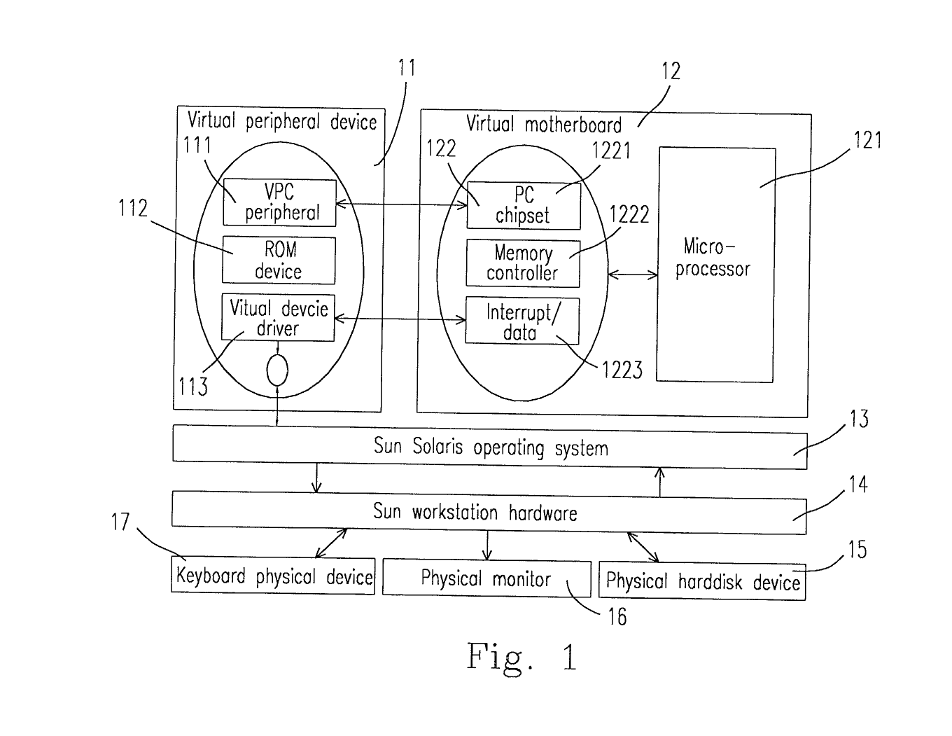

FIG. 1 is a logical block diagram illustrating the simulation system of a virtual computer verification platform according to the present invention. The simulation system comprises a virtual peripheral device 11, a virtual motherboard 12, a Sun Solaris operating system 13, a Sun workstation hardware 14, a physical harddisk device 15, a physical monitor 16 and a keyboard physical device 17.

The virtual motherboard 12 of the simulation system comprises a microprocessor 121 and a peripheral control chipset and bus interface 122. The microprocessor 121 is implemented in a Verilog hardware description language in a Behavior model, a RTL (Register Transfer Level) model or a Gate model. The peripheral control chipset and bus interface 122 includes a chipset 1221, a memory controller 1222 and interrupt/data processor 1223 and is implemented in a high level programming language, e.g. C++.

The message communication between the block 122 and the block 121 is implemented through a message passing mechanism supported by UNIX IPC (Inter-Process Communication) and a PLI (Programming Language Interface) supported by Cadence Verilog.

The virtual peripheral device 11 of the simulation system includes a VPC peripheral device 111, a ROM device 112 and a virtual device driver 113. The virtual peripheral device 11 is used for simulating the action and the status of a physical device, driving a suitable device through a System Service Call supported by UNIX and receiving message from non-synchronic and non-real time interactive devices. The information communication between the virtual peripheral device 11 and the chipset 1221 is implemented through a message passing mechanism supported by UNIX IPC (Inter-Process Communication).

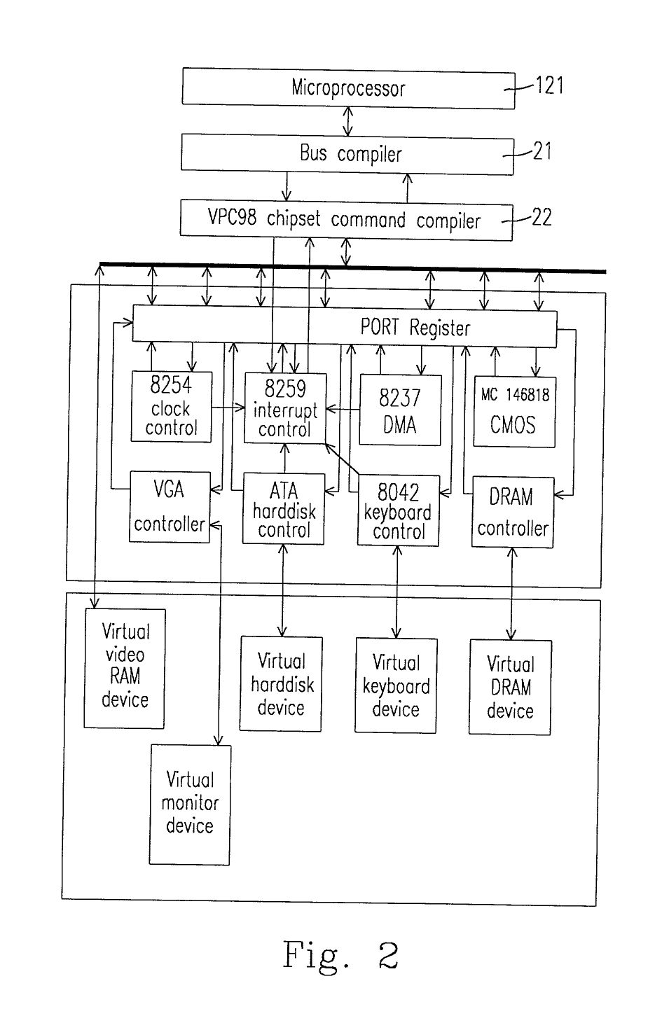

FIG. 2 is a logical block diagram showing the device of a simulation system according to the present invention. A bus compiler 21 which is connected to the microprocessor 121 and a peripheral control chipset and bus interface 122 includes two bus interfaces. These two bus interfaces includes a bus interface signal front-end transferring module which is implemented in a high level hardware description language, such as Verilog, and a bus interface signal back-end compiling module which is implemented in a programming language, such as C++. The type of bus interface is varied depending on the microprocessor. Preferably, the bus interface is Socket 7.

The simulation system is implemented by using a clock-based simulation, wherein the simulation system and the circuit of the microprocessor chip need to have the same reference clock. The reference clock can be provided by using a special function vpm_call () to process the microprocessor from the simulation system or by delivering a synchronic clock into the simulation system beyond the microprocessor.

In the preferred embodiment according to the present invention, the reference clock is provided by delivering a synchronic clock from the microprocessor with the special function into the simulation system. The concurrent-clock circuit inserted into the microprocessor chip is used for creating a synchronic clock between the simulation system and the microprocessor chip, collecting the interface signal from the microprocessor in each clock cycle, delivering the special function into the simulation system beyond the microprocessor chip in a leading edge and a trailing edge of each synchronic clock cycle, and waiting for a result to achieve synchronic transfer and data transfer. The interface signal includes an interactive input, e.g. a keyboard input, and a device-driven event, e.g. a harddisk control signal and a system management interrupt (SMI). The interface signal is collected and delivered in a array into the microprocessor in the leading edge and trailing edge of each synchronic clock cycle.

The simulation of a peripheral device is coded by simulating the action and command of a physical chip and a physical interface protocol, wherein the objects is integrated by using the subsystem of the simulation system according to the present invention and implemented by using a C++ programming language. The peripheral device is capable of debugging, collecting and correcting data, which helps verifying and debugging the circuit of microprocessor chips and interface protocol. Furthermore, the ability of modifying the contents of the peripheral device on-line is useful to assist debugging functions of the microprocessor chip. Taking a memory device for example, when the executing mode of the microprocessor is switched, the system table stored in the memory device can be easily understood whether it is normal or not. If the system table stored in the memory device is not normal, the user can try to modify the record of the system table on-line temporarily for assisting the microprocessor forward in debugging, thereby shortening the debugging time. Apparently, such debugging functions facilitate developing a new operation system and a new BIOS firmware.

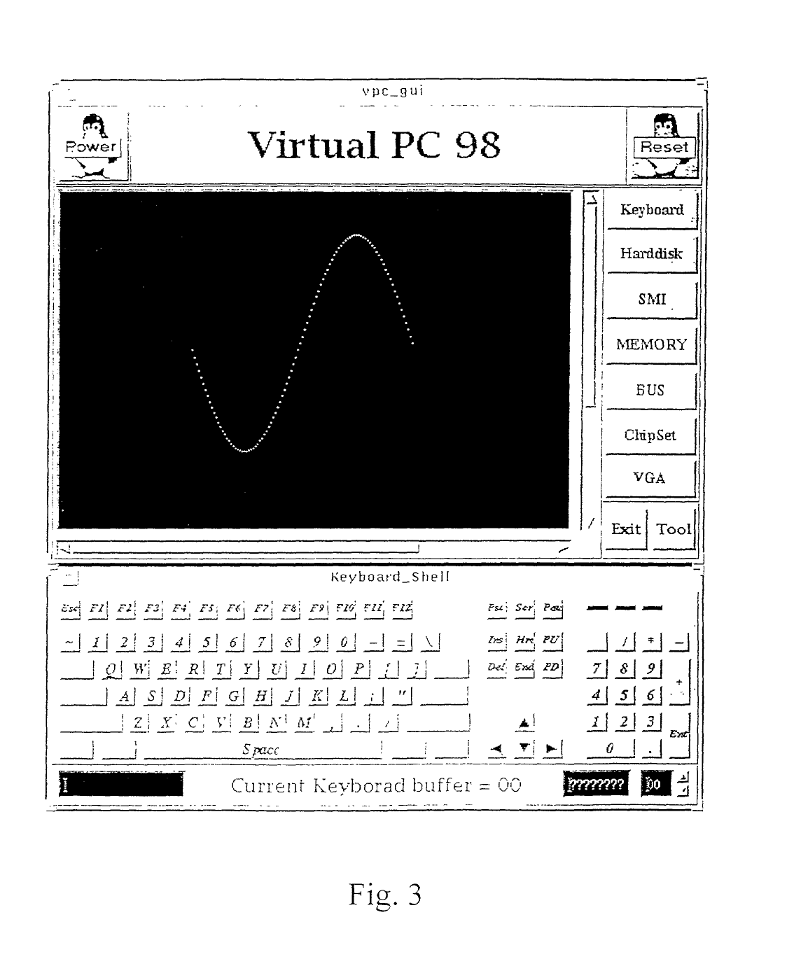

FIG. 3 is an operating window interface displaying a virtual computer verification platform according to the present invention. The operating window is implemented by using an X-Windows interface, a Motif program library, a UNIX standard system service program library, a Perl programming language and a Tcl/Tk. The operating window is equipped with a monitor window, a keyboard simulator and some functional buttons (or keys), such as Power, Reset, Keyboard, Harddisk, MEMORY, BUS, ChipSet, VGA, Exit and Tool. The monitor window is used for displaying the simulation of a physical monitor in a text mode and a drawing mode by incorporating with the VGA controller of the simulation system. Pushing down the Power button will turn on/off the simulation system of the microprocessor and start/stop the simulation of other devices in the virtual computer verification system. The simulation about the SMI external interrupt of the host computer is implemented by pushing down the SMI button, thereby the microprocessor getting into a system management mode. Pushing the Harddisk button can call various auxiliary tools, such as partition and labeling of the harddisk, formatting a MS-DOS file, copying a file, deleting a file, establishing a directory, deleting a directory and installing BIOS.

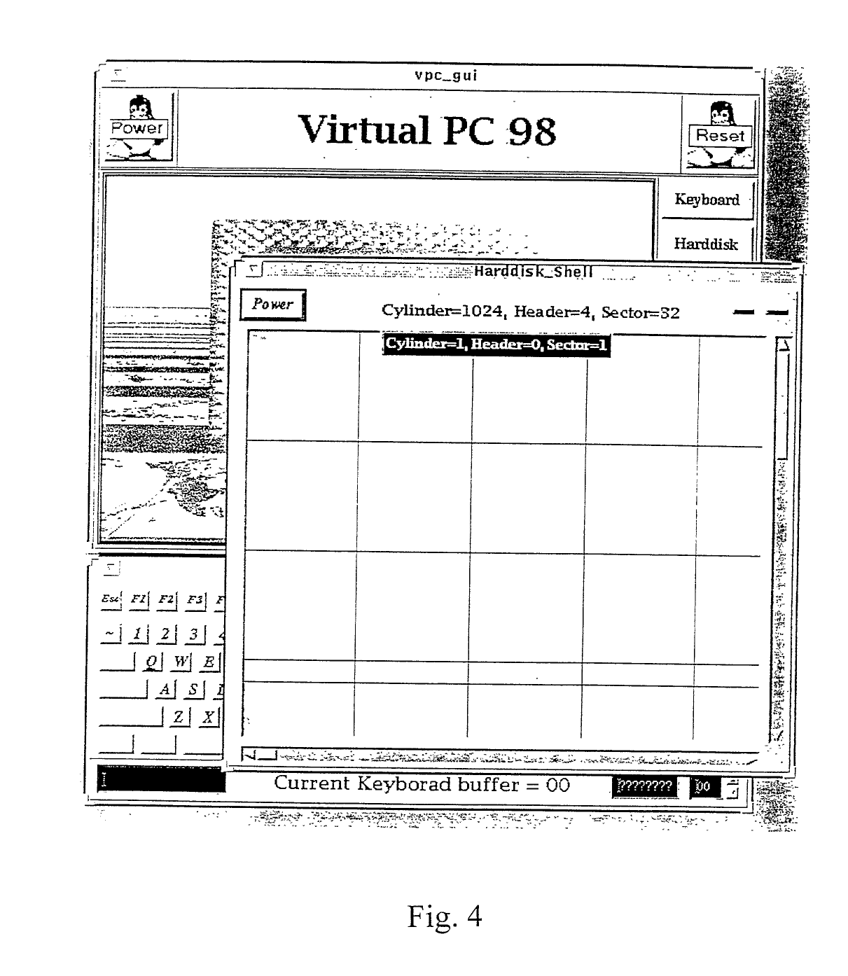

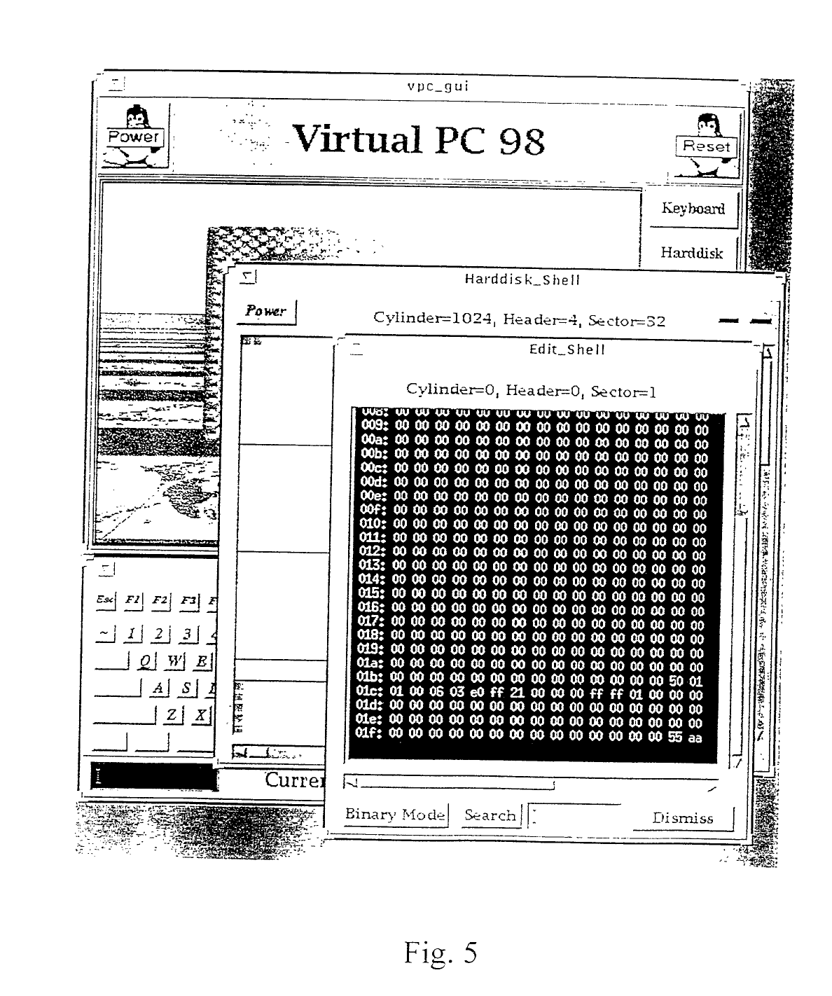

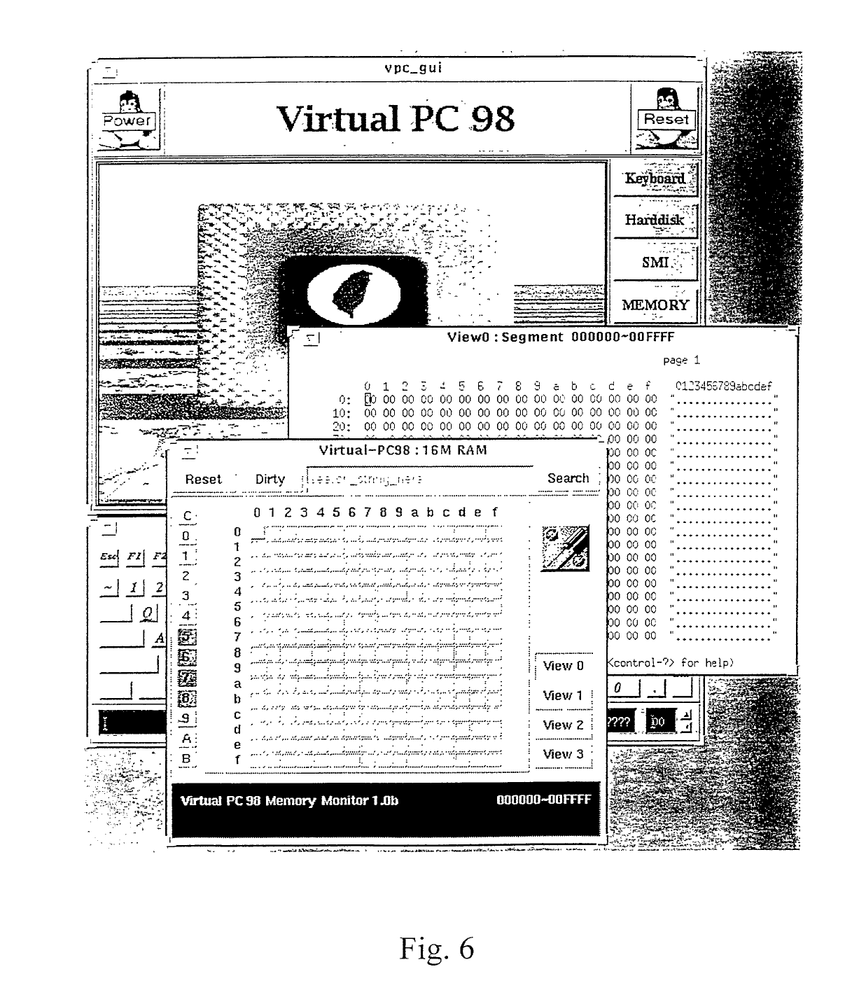

Please refer to FIG. 4. The operating window interface displays the simulation of a virtual harddisk. The terms “Cylinder”, “Header” and “Sector” showing in the operating window represents the capacity of the harddisk. Each blank grid represents a storage cell wherein no data is stored; however, the filled grid represents the storage cell storing data. FIG. 5 is another operating window interface displaying the edit window for a virtual harddisk. The data in the harddisk can be edited by a text mode or a binary mode. Pushing down the MEMORY button can modify, edit and check the contents of the virtual memory device, which can be seen in FIG. 6.

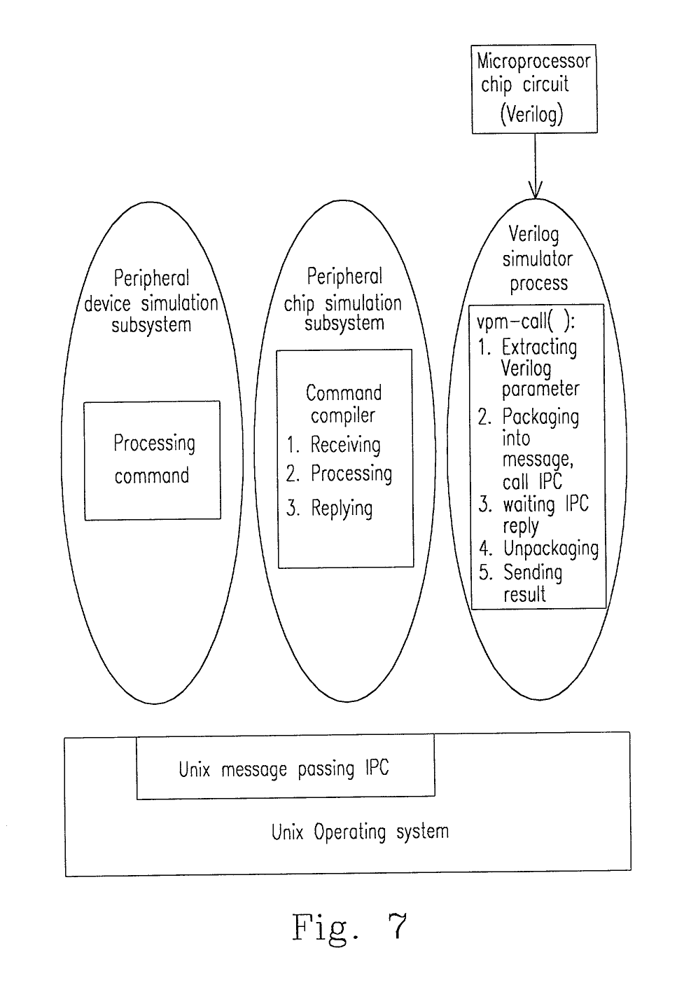

FIG. 7 is a block diagram illustrating the information communication of the simulation system according to the present invention. In FIG. 7, the simulation system is performed by a peripheral chip simulation subsystem, a peripheral device simulation subsystem, a Verilog simulator Process, a microprocessor chip circuit and a UNIX operation system. The microprocessor chip is coded in a high level hardware description language, such as Verilog. The Verilog simulator process is implemented by using a special function, vpm_call (), written in a C high level programming language. The Verilog type parameter is extracted by using the vpm_call () through a Verilog PLI (Programming Language Interface) supported by Cadence and transferred into a C type parameter. The C type parameter is then formatted into binary standard character and transferred into the simulation system of the virtual computer implemented in C++ programming language in a Blocking mode through a message passing mechanism supported by UNIX IPC (Inter-Process Communication). When the simulation system of the virtual computer sends back the result of the communication message, the vpm_call () is used for transferring the result parameters into a Verilog type parameter which is then sent back to the Verilog simulator.

In this simulation system, the programming code of the microprocessor is read and compiled by the Verilog simulator. When the programming code of the microprocessor call the vpm_call (), the Verilog simulator will call the vpm_call () for packaging the extracted Verilog parameter into a message, transferring the message to the UNIX operating system and then to the command compiler of the peripheral chip simulation subsystem. When the command compiler of the peripheral chip simulation subsystem receives a command, the command will be transferred to the corresponding virtual peripheral device and processed. The reply of the processed command will be transferred to the UNIX operation system and sending the reply to the Verilog simulator.

While the foregoing has been described in terms of preferred embodiments of the invention, it will be appreciated by those skilled in the art that many variations and modifications may be made without departing from the principles and spirit of the invention, the scope of which is defined by the appended claims.

What is claimed is:

1. A virtual computer verification platform, comprising:
a simulation system which includes a special function for integrating a microprocessor chip with the simulation system, a concurrent-clock circuit inserted into said microprocessor chip, a peripheral chip simulation subsystem, a peripheral device simulation subsystem and a bus command compiler; and
a set of on-line debugging auxiliary tools which are connected to said virtual computer simulation system for modifying the contents of said peripheral device to assist said microprocessor chip in debugging.

2. The virtual computer verification platform according to claim 1, wherein said microprocessor chip is designed in a Behavior model, a RTL model and a Gate model.

3. The virtual computer verification platform according to claim 1, wherein said microprocessor chip is coded in a high level hardware description language, Verilog.

4. The virtual computer verification platform according to claim 1, wherein said special function is vpm_call ( ) written in a C high level programming language and is used for transferring an interface signal from said microprocessor chip to said peripheral chip simulation subsystem through a message passing mechanism supported by UNIX IPC (Inter-Process Communication) and PLI (Programming Language Interface) supported by Verilog.

5. The virtual computer verification platform according to claim 4, wherein said concurrent-clock circuit is used for creating a synchronic clock between said simulation system and said microprocessor chip, collecting said interface signal from said microprocessor in each clock cycle, delivering said special function into said simulation system beyond said microprocessor chip in a leading edge and a trailing edge of each synchronic clock cycle, and waiting for a result to achieve synchronic transfer and data transfer.

6. The virtual computer verification platform according to claim 1, wherein said peripheral chip simulation subsystem is used for integrating each individual virtual peripheral chip and is designed in terms of an object-oriented programming technology for providing a peripheral control chipset of the simulation system with performance, interface protocol and clock.

7. The virtual computer verification platform according to claim 1, wherein said peripheral device simulation subsystem is used for integrating individual virtual peripheral device and is designed in terms of an object-oriented programming technology for providing a peripheral device of the simulation system with performance.

8. The virtual computer verification platform according to claim 1, wherein said bus command compiler is used for compiling a protocol signal command from said microprocessor chip and transferring a compiled command into said peripheral chip simulation subsystem.

9. The virtual computer verification platform according to claim 1, wherein said set of on-line debugging auxiliary tools comprises:
a Graphic User Interface which is implemented by using a C++ programming language in terms of a X-Windows, a Motif program library, a UNIX standard system service program library, a Perl programming language and a Tcl/Tk;
a first compiler for displaying and revising contents of a memory;
a second compiler for displaying and revising contents of a virtual harddisk;
a set of harddisk low level management tools capable of reading a parameter table of the virtual harddisk and formatting the virtual harddisk in low level;
a set of MS-DOS compatible file system management tools for implementing a file system operation of simulation system when no operating system is executed, including partition and labeling of the harddisk, formatting a MS-DOS file, copying a file, deleting a file, establishing a directory, and deleting a directory for facilitating the operation system installation of the simulation system; and
a Basic Input Output System (BIOS) chip written tool for writing a ROM image file of a new BIOS program into said microprocessor chip of said simulation system.
